(19) United States
(12) Patent Application Publication
(10) Pub. No.: US 2004/0049914 A1
(43) Pub. Date: Mar. 18, 2004

(54) Method for making a coaxial electrical contact

(76) Inventors: Shengjie Wang, Sunnyvale, CA (US); Zhineng Fan, Sunnyvale, CA (US)

Correspondence Address: SAMUEL W. APICELLI, DUANE MORRIS LLP, 305 NORTH FRONT STREET, P.O. BOX 1003, HARRISBURG, PA, 17108-1003, US

(21) Appl. No.: 10/634,927

(22) Filed: Aug. 5, 2003

Related U.S. Application Data
(63) Continuation-in-part of application No. 10/241,945, filed on Sep. 12, 2002.

(51) Int. Cl. H01R 43/00; B23P 17/00

(52) U.S. Cl. 29/884; 29/417; 29/868

(57) ABSTRACT

The present invention provides a process for forming a contact member cable. The cable is a longer version of a contact member and can then be cut into shorter, individual contact members, to meet the particular requirements for a specific connector application. The contact members can be used as the conductive elements for a family of land grid array connectors that provide, among other things, a low profile, uniform electrical and mechanical performance, and reworkability if a contact member is damaged. The connectors are intended to interconnect electrical circuit members such as printed circuit boards, circuit modules, or the like. Such circuit members may be used in information handling system (computer) or telecommunications environments.

### CROSS-REFERENCE OF RELATED APPLICATION

This application is a continuation-in-part application of copending U.S. application Ser. No. 10/241,945, filed on Sep. 12, 2002.

### FIELD OF THE INVENTION

The present invention generally relates to interconnection systems for high speed electronics systems, and more particularly to a shielded elastomeric contact adapted for use in several different connector systems that are capable of high speed data transmission.

### BACKGROUND OF THE INVENTION

Electrical connectors that are mounted to a printed circuit board are well known in the art. As the size of the electronic devices in which the printed circuit boards are installed has decreased, the density of the connectors positioned on those boards has increased. Such electronic devices also require electrical connectors, with numerous terminals to be mounted on a printed circuit board in such a manner as to occupy a minimal area of printed circuit board real estate, while at the same time capable of transmitting ever higher data rates.

In order to provide for a higher density of connectors on printed circuit boards, surface mount technology was utilized. With surface mounting, the conductive pads on the printed circuit board can be closely spaced, thereby allowing more contacts to be mounted in the same area of the board. As the density of the connectors on the printed circuit board increases, the length of the terminals cannot increase significantly without degrading the electrical performance of the electronic device. This is particularly true in electronic devices designed for high speed applications. Typically, high density connectors, which have the shortest path over which the signals must travel, operate optimally. As the density of interconnects increases, and the pitch between contacts approaches 0.5 mm or less, the close proximity of the terminal contacts increases the likelihood of strong electrical cross-talk coupling between the terminal contacts. In addition, maintaining design control over the characteristic impedance of the terminal contacts becomes increasingly difficult.

The design control difficulties associated with maintaining the characteristic impedance within the necessary limits for optimum high speed data transfer are compounded when such high speed signals must be transmitted between spaced apart systems. Most often, coaxial-type cables and connectors are employed for such data transmission applications. Coaxial cable typically comprises a center conductor that is surrounded by overlapping layers of insulator material and electrical shielding material that extend the length of the transmission line. Coaxial connectors often have a circular center contact, a hollow cylindrical outer contact, and a tubular insulation between them. Such coaxial connectors are interconnected to coaxial cable by electrically and mechanically engaging the center conductor to the center contact and the shielding material to the hollow cylindrical outer contact. Retention features generally must be attached to the outside of the outer contact, since their insertion into slots in the insulation would result in a sudden change in impedance there, resulting in reflectance of signals and consequent increase in the VSWR (voltage standing wave ratio) and signal losses. Each coaxial type connector has a defined characteristic impedance with 50 ohms being the most common, and with losses increasing with deviations from the defined characteristic impedance at locations in the connector.

The traditional cylindrical shapes used in these types of connector systems often require relatively expensive manufacturing methods, such as machining of the inner contact, to form the coax connector assembly. Such assemblies are normally to large to be of any practical use in a printed wiring board to printed wiring board application. A coaxial-type contact assembly, or connector, with inner and outer contacts separated by insulation, for carrying signals in the range of megahertz and gigahertz, which could be constructed at low cost in a board-to-board configuration would be of significant value.

Modern electronics requires the use of high frequency and high speed connectors particularly for use in interconnecting circuitry on motherboards or backplanes and daughter cards or other circuit devices. These connectors have often times required shielding or ground planes between the signal pins; e.g., stripline configuration, to provide high frequency signal integrity and minimize interference from outside sources.

For example, U.S. Pat. No. 6,264,476 discloses an interposer for a land grid array that includes a dielectric grid having an array of holes and a resilient, conductive button disposed in one or more of the holes. The button includes an insulating core, a conducting element wound around the insulating core, and an outer shell surrounding the conducting element. The characteristics of the conducting element and the buttons may be chosen such that the contact force, contact resistance, and compressibility or relaxability of the conductive buttons can be selected within wide limits. The interposer design utilizing such conductive buttons is quite compatible with high data rate, high frequency and high current applications.

For some applications, however, it is desirable to have a highly dense array or grid of contact members, while maintaining the integrity between the lines, in a board-to-board configuration. As the center line spacing between contact members in a row is decreased, the spacing between adjacent columns of contact members is likewise decreased, thereby necessarily reducing the amount of dielectric housing material between the members of the array. This, in turn, affects the electrical characteristics of the connector system, and in particular reduces the impedance through the connector system. It is desirable, therefore, to have an electrical connector that provides a dense array of contact members, with the impedance characteristics often only found in coaxial connector systems, and arranged in a board-to-board connector system, while maintaining the electrical characteristics associated with connectors having a less dense array of contact members.

Though there are many types of connectors available, it would be desirable to have a connector with a precisely controlled impedance to reduce signal reflections. It would also be desirable to have a connector which could accommodate fast signals, those with rise times on the order of 250 psec or less. Such a connector should also be durable while at the same time being detachable so that printed circuit printed wiring boards can be joined and separated during use.

### SUMMARY OF THE INVENTION

In one embodiment of the invention, a method for making an electrical contact is provided that comprises the steps of advancing a center resilient body along a predetermined path of travel and arranging a plurality of elongate wires around that center resilient body. A dielectric layer applied around the plurality of elongate wires and the center resilient body so as to form an axially continuous contact-cable. The contact-cable is then cut repeatedly so as to form a plurality of individual electrical contacts. In a preferred embodiment of the invention both the advancing and applying steps utilize a fluoropolymer.

### BRIEF DESCRIPTION OF THE DRAWINGS

These and other features and advantages of the present invention will be more fully disclosed in, or rendered obvious by, the following detailed description of the preferred embodiment of the invention, which is to be considered together with the accompanying drawings wherein like numbers refer to like parts and further wherein:

FIG. 1 is a partially exploded, perspective view of a coaxial elastomeric connector system formed in accordance with the present invention;

FIG. 2 is a perspective view of a flex circuit base connector system formed in accordance with the present invention;

FIG. 3 is a perspective view, partially in phantom, of a compressible contact formed in accordance with the present invention;

FIG. 4 is a perspective view of a plurality of flexible connecting elements wound around a compressible insulating core;

FIG. 5 is a cross-sectional view of a compressible insulating core having a plurality of flexible conducting elements wrapped around it, as taken along the lines 55 in FIG. 4;

FIG. 6 is a perspective view similar to that shown in FIG. 4, but including a compressible outer shell 26;

FIG. 7 is a cross sectional view of a compressible insulating core having a plurality of flexible conducting elements wrapped around it, and encased within a compressible outer shell, as taken along lines 77 in FIG. 6;

FIG. 8 is a perspective view of a plurality flexible conducting elements wrapped around a compressible insulating core, encased within a compressible outer shell 6 and further shielded by shielding layer;

FIG. 9 is a cross-sectional view of FIG. 8 as taken along lines 99 in FIG. 8;

FIG. 10 is a perspective view similar to FIG. 8, but including an additional shielding layer;

FIG. 11 is a cross-sectional view of FIG. 10 as taken along the lines 11 in FIG. 10;

FIG. 11 a is a perspective view similar to FIG. 10, but including an additional shielding layer that has been wrapped around a plurality flexible conducting elements disposed upon a compressible insulating core;

FIG. 12 is a perspective view, partially broken away of a contact formed in accordance with the present invention arranged just prior to engagement with a contact pad positioned on a portion of a printed wiring board;

FIG. 13 is a is a perspective view of a flex circuit connector system formed in accordance with the present invention;

FIG. 14 is a partially broken away, perspective view of a contact formed in accordance with the present invention arranged just prior to engagement with a contact pad on a flex circuit;

FIG. 15 is a front elevational view of a contact pad having a surface trace formed on a flex circuit;

FIG. 16 is a front elevational view of an alternate contact pad having a signal trace exiting through a printed wiring board;

FIG. 17 is a further alternative embodiment of board to board interconnect/jumper system formed in accordance with the present invention;

FIG. 18 is a exploded perspective view of an interposer adapted for interconnecting a microprocessor or like semi-conductor device to a printed wiring board;

FIG. 19 is a perspective view of an alternative shielding layer having a plurality of wires, with each wire being wound in a spiral having a direction of wind, and where the direction of wind of at least one of the wires is an opposite direction to the direction of wind of at least one of the other wires;

FIG. 20 is a perspective view of an alternative shielding layer comprising a conductive wire mesh;

FIG. 21 is a perspective view of an alternative shielding layer comprising a continuous metallic layer;

FIG. 22 is schematic representation of a typical manufacturing system for forming a continuous length of contact-cable in accordance with the present invention; and

FIG. 23 is schematic representation of a typical cutting system for forming a plurality of electrical contacts from a continuous length of contact-cable in accordance with the present invention.

### DETAILED DESCRIPTION OF THE PREFERRED EMBODIMENT

This description of preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In the description, relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. In the claims, means-plus-function clauses are intended to cover the structures described, suggested, or rendered obvious by the written description or drawings for performing the recited function, including not only structural equivalents but also equivalent structures.

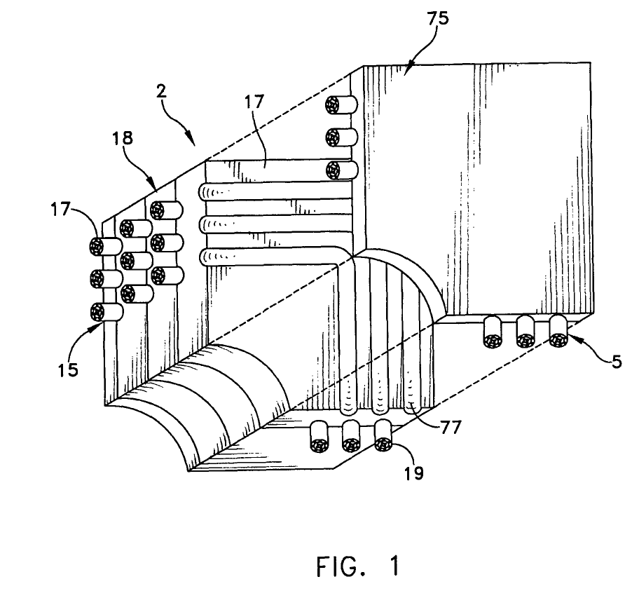

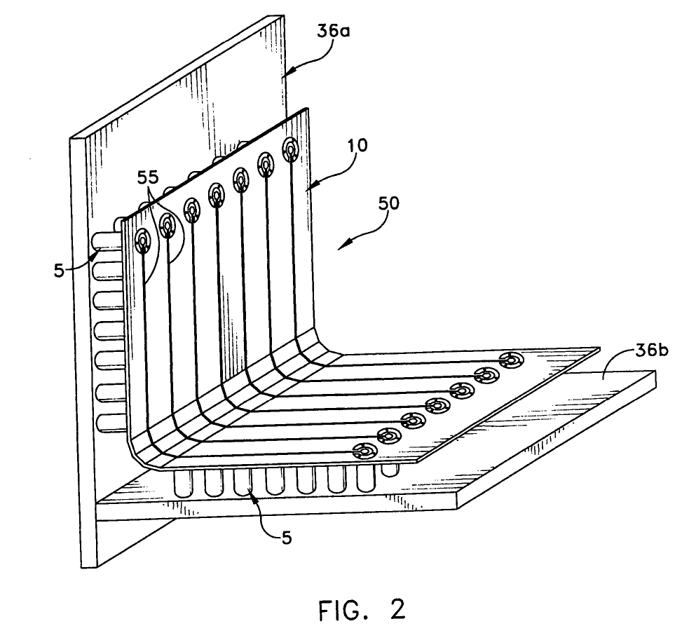

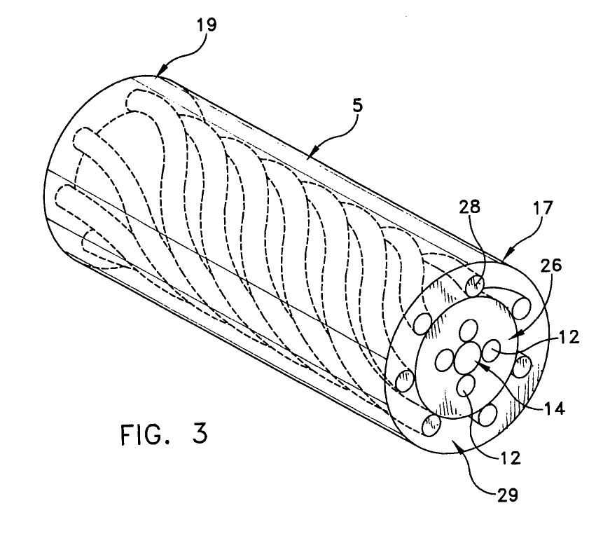

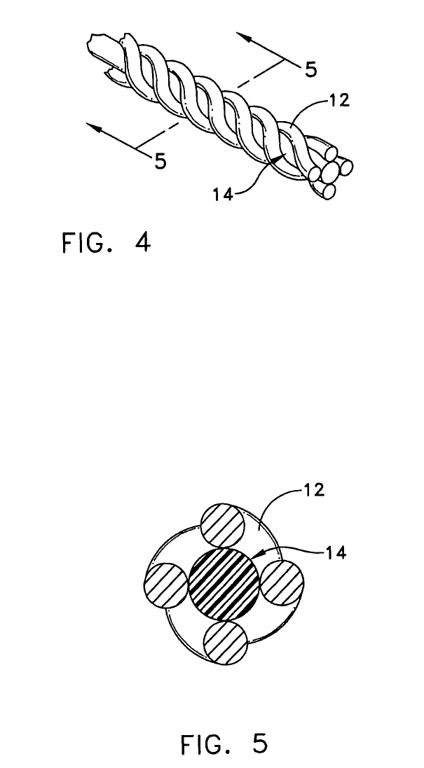

Referring to FIGS. 1 and 2, connector system 2 formed in accordance with the present invention comprises a plurality of elastomeric contacts 5 assembled within a housing block 18, or to portions of a flex circuit 10. More particularly, each elastomeric contact 5 comprises at least one flexible conducting element 12 wound around a compressible insulating core 14 extending from first end 17 to second end 19 of contact 5 (FIGS. 3-4). Suitable materials for flexible conducting elements 12 include gold, copper, and other metals or metal alloys of low specific resistivity. Non-noble metals can be plated or coated with a barrier metal covered with a surface structure of gold or other noble metals to ensure chemical inertness and provide suitable asperity distribution to facilitate good metal-to-metal contact.

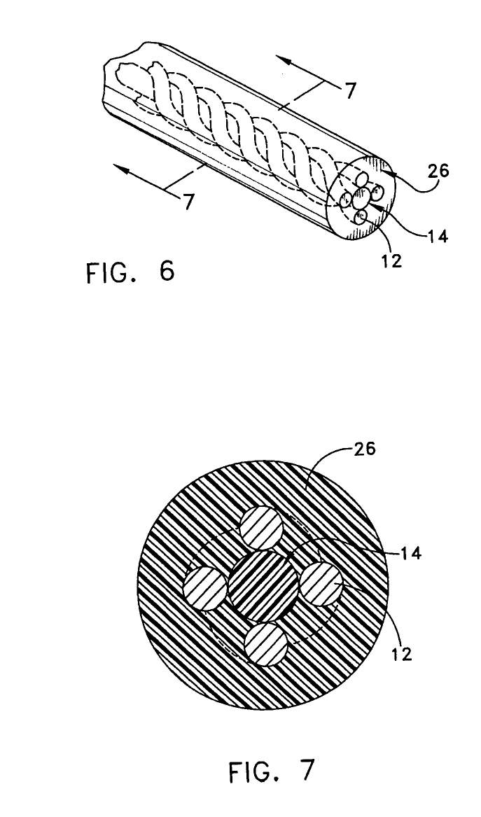

Compressible insulating core 14 preferably comprises a fluoropolymer or other suitable resilient dielectric material (FIG. 5). A compressible, insulating outer shell 26 is arranged in surrounding relation to flexible conducting elements 12, and periodically engages portions of flexible conducting elements 12 and compressible insulating core 14 (FIGS. 3, 6 and 7). Flexible conducting elements 12 and compressible insulating core 14 are embedded in compressible outer shell 26 which may be formed from one of the well known elastomeric polymers, e.g., silicone rubber, neoprene, polybutadiene, or similar polymeric materials. In this way, the shell-to-conducting element engaging portions are along substantially the entire surfaces of each of flexible conducting elements 12. Preferably, compressible outer shell 26 is formed from one of the many fluoropolymers which are substantially free of hydrogen, especially melt-processable copolymers of tetrafluoroethylene with suitable comonomers, such as hexafluoropropylene and perfluoroalkoxyalkenes. Suitable commercially available copolymers include those sold by E. I. Dupont de Nemours under the trade names Teflon FEP and Teflon PFA.

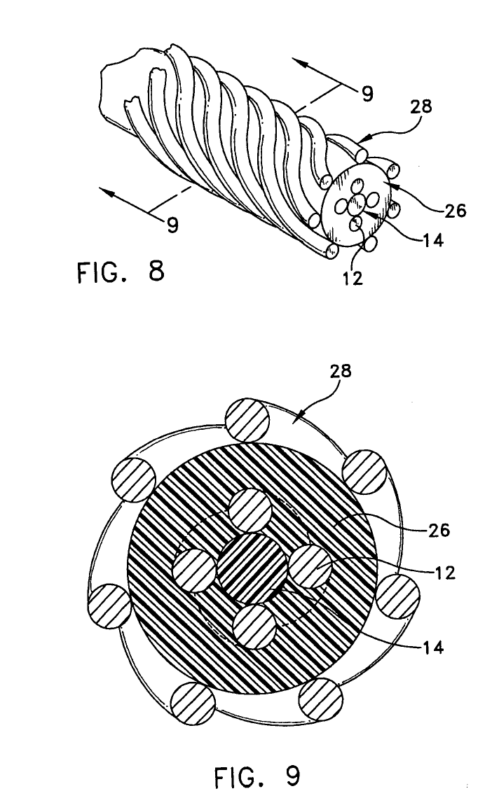

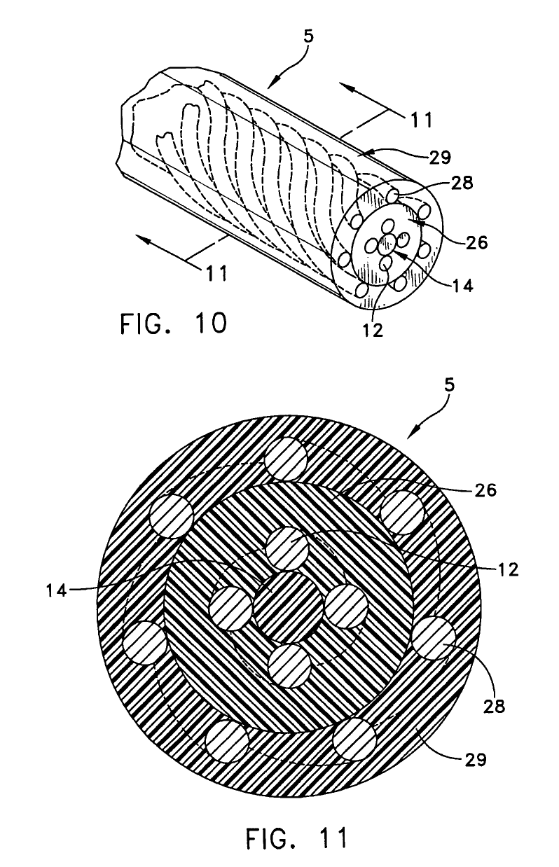

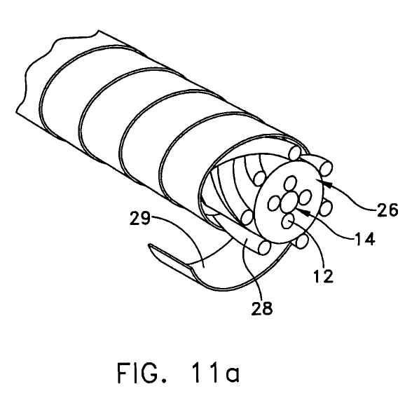

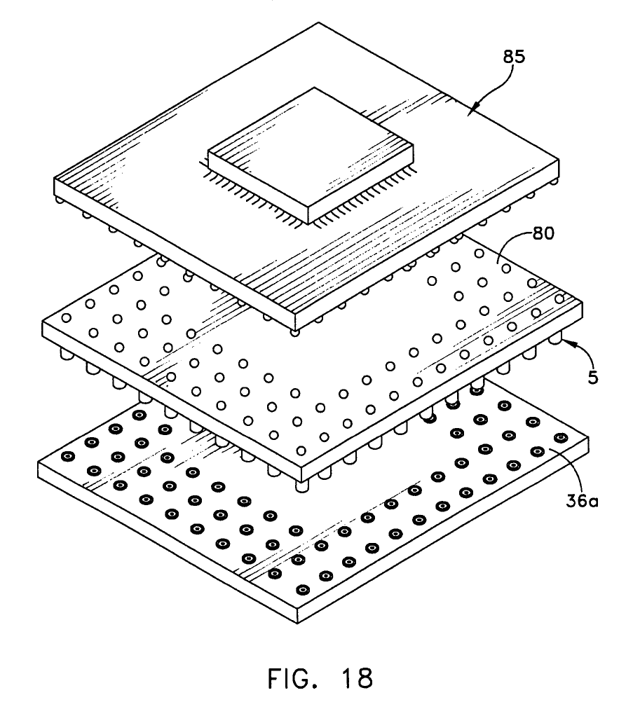

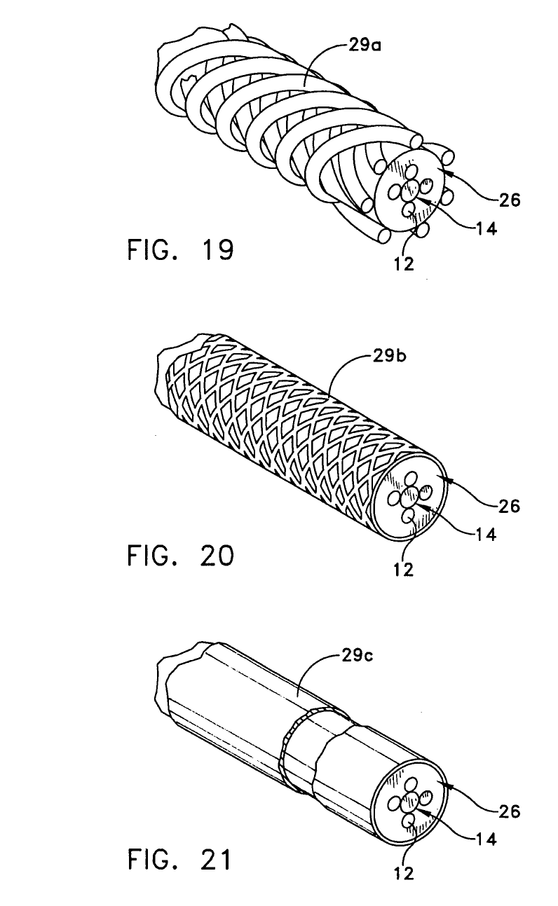

Contacts 5 are preferably shielded with at least one electrically conductive shielding layer 28 made of individual conductors, wire mesh or, alternatively, a continuous metallic layer, that is arranged in surrounding relation to compressible outer shell 26 and insulating core 14 that is positioned over the inner lying flexible conducting elements 12 (FIGS. 3, and 8-11). This arrangement is analogous to a coaxial cable conductor where the central conductor is surrounded by one or more outer conductive shield layers. Shielding layer 28 is often protected by one or more additional dielectric and/or shielding layers 29. In addition, a variety of arrangements of shielding layer may be employed with the present invention (FIG. 11). For example, one shielding layer 29a includes a plurality of wires, with each wire being wound in a spiral having a direction of wind, and where the direction of wind of at least one of the wires is an opposite direction to the direction of wind of at least one of the other wires (FIG. 19). Also, a dielectric layer 29 may be formed from one of the many fluoropolymers which are substantially free of hydrogen, especially melt-processable copolymers of tetrafluoroethylene with suitable comonomers such as hexafluoropropylene and perfluoroalkoxyalkenes. Suitable commercially available copolymers include those sold by E. I. Dupont de Nemours under the trade names Teflon FEP and Teflon PFA may be applied by wrapping (FIG. 11 a). Alternatively, a conductive wire mesh 29b (FIG. 20) or a continuous metallic layer 29c (FIG. 21) may be used without deviating from the scope of the present invention. Of course, it will be understood that is each embodiment of the invention, an insulating layer surrounds the shielding layer.

Contacts 5 can be manufactured by first making a cable-like structure, via an extrusion process, and then cutting the cable-like structure into pieces having preselected lengths. Contacts 5 may also be made by other conventional methods, such as injection molding. More particularly, the method of the present invention for forming a plurality of contacts 5 generally comprises providing a continuous length of compressible insulating core 14, e.g., an elongate solid or tubular fluoropolymer core. A plurality of conducting elements 12 are wound around compressible insulating core 14 in substantially surrounding relation. In one embodiment, conducting elements 12 form a helical coil that surrounds compressible insulating core 14. A dielectric layer 29 is applied over top of conducting elements 12 and compressible insulating core 14 so as to substantially surround both thereby forming a contact-cable 30. Contact-cable 30 is then repeatedly and sequentially cut so as to form a plurality of discrete contacts 5. As indicated herein above, dielectric layer 29 may be applied by wrapping (FIG. 11a), extrusion or coating. Additional layers of conductors and dielectric materials may then be applied to form a variety of shielded contacts 5.

Several design considerations go into determining the materials and dimensions of the various components for making contact-cable 30. They include determining the outer diameter, the mechanical, electrical, and physical parameters, the end-use environmental conditions, and understanding how the materials will react/interact with adjoining materials.

Compressible insulating core 14 allows a continuous manufacturing flow and a physical surface onto which conducting elements 12 may be wrapped to form contact-cable 30. Compressible insulating core 14 is preferably made of a polymeric material. Here again, a preferred material is one of the many fluoropolymers which are substantially free of hydrogen, especially melt-processable copolymers of tetrafluoroethylene with suitable comonomers such as hexafluoropropylene and perfluoroalkoxyalkenes. Suitable commercially available copolymers include those sold by E. I. Dupont de Nemours under the trade names Teflon FEP and Teflon PFA. Other desirable properties for compressible insulating core 14 are low moisture absorbance, minimal shrinkage, lack of dyes, high tensile strength, low compression force, high melting point, relatively uniform diameter. A low tear strength in compressible insulating core 14 aids in performing a cutting process for the later forming of individual contacts 5.

Conducting elements 12 provide a continuous, and preferably redundant electrical path from a first end of contact-cable 30 to a second end. Once subdivided into individual contacts 5, conducting elements 12 act mechanically as a spring, as well as signal, power or ground interconnection paths. The material for conducting elements 12 is chosen based on mechanical, electrical, and physical requirements. Suitable examples are copper alloys such as cadmium copper, phosphor-bronze and beryllium copper, which are commonly used in the interconnection industry. Desirable properties for conducting elements 12 include high electrical conductivity, low bulk resistance, high yield stress, ductility, low oxidation rate, and a cross-sectional area that is selected so as to provide appropriate conductivity for a specific application. The preferred materials suitable for conducting elements 12 should also be readily available, inexpensive, and have industry-wide acceptance.

In one example, conducting elements 12 comprise four 0.002 inch diameter beryllium copper wires. There are many possible configurations for orienting conducting elements 12 on compressible insulating core 14. One way is to spirally wrap them around compressible insulating core 14, where the wire diameter, the lay length, the spatial layout, and the wrapping configuration determine how the finished contact 5 behaves mechanically and electrically. Conducting elements 12 may be spirally or helically wound in the same direction, in opposing directions, or braided. Conducting elements 12 may also be applied to compressible insulating core 14 by wrapping, braiding, winding, and twisting techniques. In other embodiments, conducting elements 12 may comprise a conductive tape. Optionally, conducting elements 12 may be plated with at least one additional layer of conductive material (e.g., gold) to enhance performance and/or reliability.

Dielectric layer 29 acts as a protective layer for contact-cable 30 from the surrounding environment, and provides electrical isolation for conducting elements 12 from shielded carriers. It will be understood that the material choice for dielectric layer 29, along with the shielded carrier, the thickness and material can be used to determine the characteristic impedance of contacts 5. The maximum thickness of dielectric layer 29 is determined by center-to-center distance between adjacent contacts 5 when mounted in either housing block 18 or flexcircuit 10.

Dielectric layer 29 is also preferably made of a polymeric material. A preferred material is one of the many fluoropolymers which are substantially free of hydrogen, especially melt-processable copolymers of tetrafluoroethylene with suitable comonomers such as hexafluoropropylene and perfluoroalkoxyalkenes. Suitable commercially available copolymers include those sold by E. I. Dupont de Nemours under the trade names Teflon FEP and Teflon PFA. Desirable properties for dielectric layer 29 include low compression modulus, low compression set, minimal reversion under end-use environmental conditions over the life of the product, low tear strength, low rate of processing defects (e.g., bubbles, voids, and contaminants), and ease of material handling in manufacture. Also, it is preferable that the material chosen for dielectric layer 29 be readily available, inexpensive, and have industry-wide acceptance. It will be understood that when wrapping dielectric layer 29 (FIG. 11 a) a suitable melting or sintering process step of the type well known in the art is required to effect adhesion and void free coverage of the underlying structures.

The rigidity of flexible conducting element 12 is selected so that when contact 5 is compressed (or the compressive force is released) the contacting portions urge an identical or substantially corresponding displacement in both flexible conducting element 12 and compressible outer shell 26, and layers 28, 29. This allows first end 17 and second end 19 of contact 5 to establish and maintain electrical and mechanical contact with between contact pads 31a, 31b that are located in a corresponding array of contact pads on printed wiring boards 36a, 36b, respectively, by means of the electrical conductors running through contact 5.

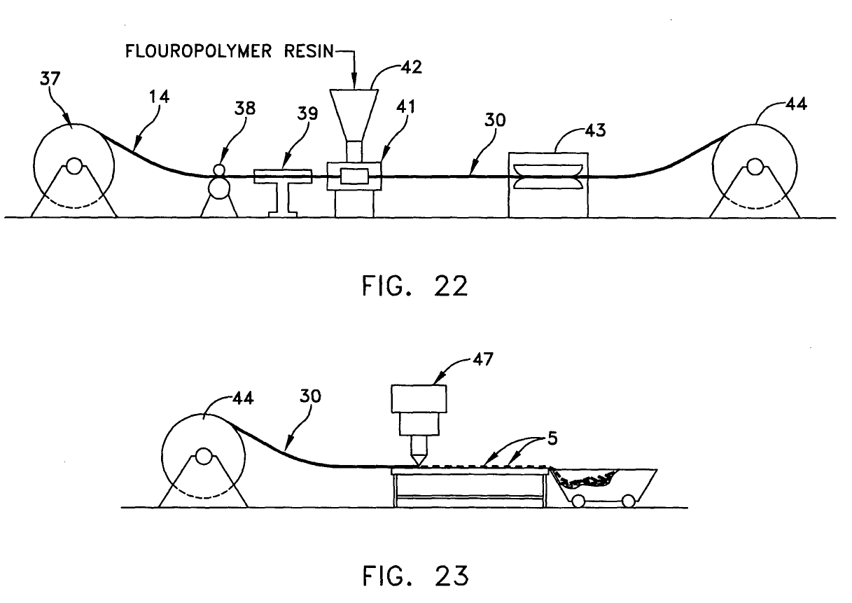

Referring to FIG. 22, an example of one manufacturing arrangement that is suitable for use with the present invention includes withdrawing a continuous length of compressible fluoropolymer insulating core 14 from a supply reel 37. A plurality of conducting elements 12 are then wrapped around compressible insulating core 14 by a wire winding, wrapping or braiding unit 38 prior to passing the assembly through a heater 39. From heater 39, compressible insulating core 14 and plurality of conducting elements 12 are passed through the crosshead of an extruder 41. A melt-extrudable fluoropolymer is fed into extruder 41 from a hopper 42, and is shaped as a coaxial dielectric layer 29 around plurality of conducting elements 12. Within extruder 41, the fluoropolymer resin is heated above its melt temperature prior to extrusion as dielectric layer 29. Cable-contact 30 is drawn through the process line by a capstan 43 and wound onto a take-up reel 44. Cable-contact 30 is then unwound from take-up reel 44 and processed through cutting station 47 where it is cut transversely into individual contacts 5. It will be understood that the cutting step exposes a second electrically accessible end of each of plurality of conducting elements 12 so as to allow for the use of each contact 5 as an electrical connection. Alternatively, a tape of dielectric material 29 may be wrapped around plurality of conducting elements 12 instead of being extruded.

It will be understood that changing the shape, number, and rigidity of flexible conducting elements 12, as well as, the shape and rigidity of the compressible insulating core 14, outer shell 26, layers 28 or 29, the contact resistance, contact force, and compressibility can be selected within a wide range. Also, flexible conducting elements 12 are completely embedded in, and may be supported by, compressible outer shell 26 and layers 28, 29 since they are too fine and flexible to stand on their own. Alternatively, flexible conducting elements 12 may contribute significantly to the mechanical stability of contact 5. The overall cumulative contact force of contacts 5 against the contact surfaces 40a, 40b of contact pads 31a, 31b is low due to the resilient construction and compressibility of contacts 5, and is preferably in the range of approximately 20 to 40 grams per contact.

Additionally, contacts 5 establish and maintain contact between each flexible conducting element 12 and its corresponding contact pads 31a,31b at a high localized contact force, sufficient to induce plastic yielding. Another factor in producing a low overall contact force is limiting the number of continuous flexible conducting elements 12 per unit surface area or volume of contact body. The number and conductivity, however, of flexible conducting elements 12 should be selected so as to produce a low total resistance, at a preselected characteristic impedance, for the connector system, preferably in the range of 10 milliohms or less per contact 5. It will also be understood that the angle of each flexible conducting element 12 at the surface of flat surface of contact 5, which is determined in the case of a winding or coil by the pitch, is a design parameter that bears a direct relation to the contact pressure required—the steeper (more vertical) the angle, the higher the force required.

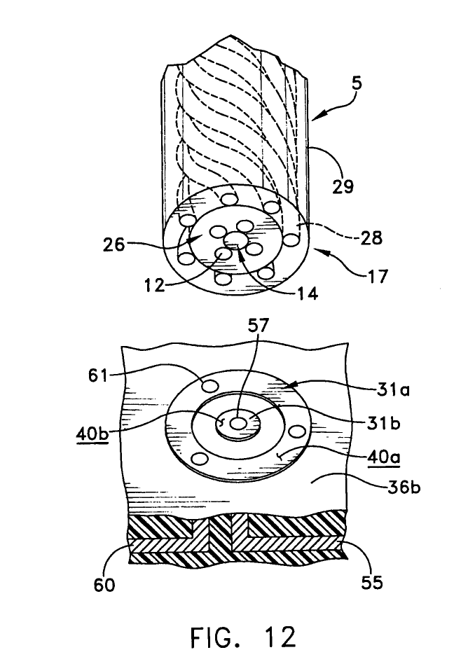

Referring to FIGS. 2 and 13, one of the important aspects of the high speed connector system of the present invention is the provision of a flexcircuit board-to-board interconnect system 50 which achieves a relatively high number of high data rate compatible electrical connections in a relatively small area, in a manner which does not substantially reduce or compromise the bandwidth of the signals conducted through the assembly of contacts 5.

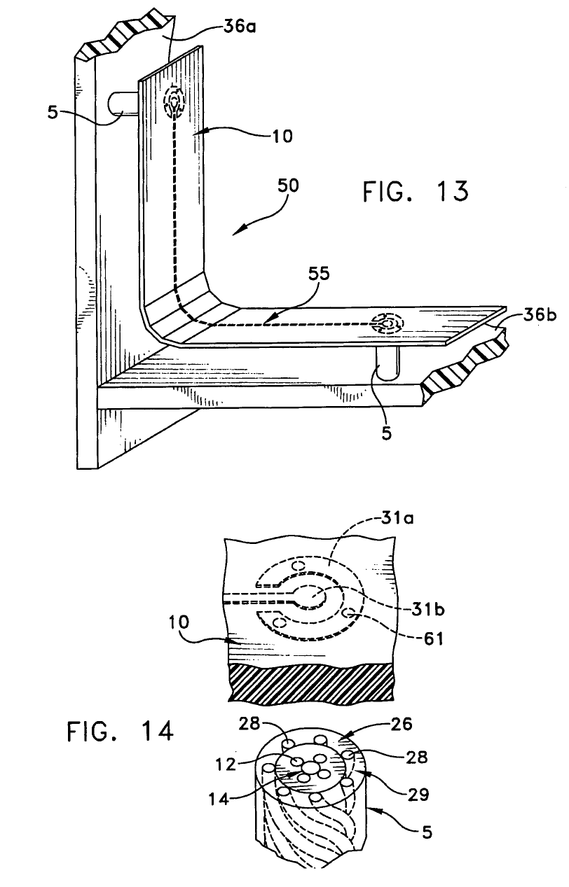

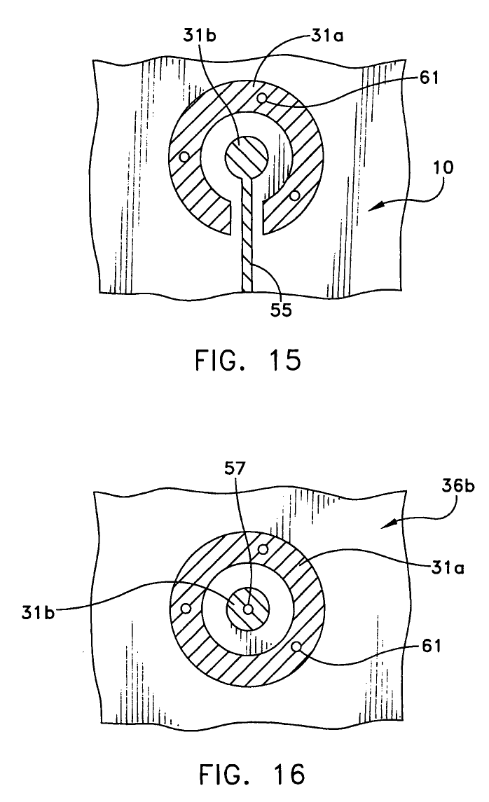

In one embodiment of the invention, flexcircuit board-to-board interconnect system 50 comprises a plurality of contacts 5 mechanically and electrically engaged with a plurality of circuit traces 55 located in flexcircuit 10. Each contact 5 is assembled to flexcircuit 10 such that one or more of its flexible conducting elements 12 is electrically connected to each respective trace 55 via contact pad 31b, and its shielding layers 28 are electrically connected to a ground plane conductor 60, via contact pad 31a. It should be understood that contact pads 31a, 31b may be arranged so as to allow for a surface exit of trace 55 through a power or signal via 57 (FIGS. 12-16) or ground plane conductor 60 through a ground via 61.

In another embodiment of the invention, a housing block 18 may be employed comprising a variety of support structures that are suitable for arranging and supporting contacts 5. The electrical and mechanical characteristics of connector system 2 may be optimized by careful selection of the material for housing block 18 based on such factors as cost, rigidity, thermal stability, and inertness to humidity and air and chemical impurities. Suitable materials for housing block 18 include polymers having a low and uniform dielectric constant, such as any of the well known dielectric, polymer materials that are suitable for injection molding, and are commonly used in the connector or semiconductor packaging industry, e.g., polyhalo-olefins, polyamides, polyolefins, polystyrenes, polyvinyls, polyacrylates, polymethacrylates, polyesters, polydienes, polyoxides, polyamides and polysulfides and their blends, co-polymers and substituted derivatives thereof.

For example, housing block 18 may comprises a plurality of injection molded shells 75, each having one or more internal receptacle guides 77 that are sized and shaped so as to receive an elongate contact 5. In this way, a board-to-board connector 2 may be formed having a plurality of contacts 5 arranged so as to provide for either ninety degree or parallel positioning of the mated printed wiring boards. Alternatively, contacts 5 may be insert molded during the formation of housing block 18 to form a board-to-board connector 2.

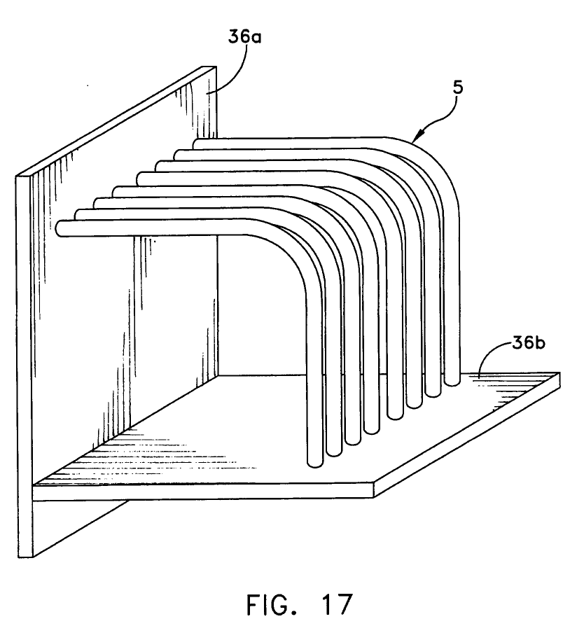

Referring to FIG. 17, in a further embodiment of the present invention, a plurality of contacts 5 may be used as jumpers between printed wiring boards 36a, 36b. In this embodiment, a plurality of contact pads 31a, 31b are arranged in an array on the surfaces of printed wiring boards 36a and 36b, with first end 17 and second end 19 of each contact 5 electrically and mechanically engaged with a corresponding contact pad 31a, 31b. It will be understood that conventional soldering or brazing methods may be used to facilitate the mechanical and electrical interconnection between contacts 5 and contact pads 31a, 31b.

Referring to FIG. 18, an interposer 80 may be formed having a plurality of contacts 5 arranged on one or both surfaces so as to provide an interconnection between a printed wiring board 36a and a microprocessor package 85 that is to be arranged on printed wiring board 36a.

It is to be understood that the present invention is by no means limited only to the particular constructions herein disclosed and shown in the drawings, but also comprises any modifications or equivalents within the scope of the claims.

What is claimed is:

1. A method for making an electrical contact comprising the steps of:
advancing a center resilient body along a predetermined path of travel;
arranging a plurality of elongate wires around said center resilient body;
applying a dielectric layer around said plurality of elongate wires and said center resilient body so as to form an axially continuous contact-cable; and
cutting repeatedly said contact-cable so as to form a plurality of individual electrical contacts.

2. The method according to claim 1 wherein said arranging step comprises arranging the elongate wires helically around the underlying resilient body.

3. The method according to claim 1 further comprising the step of arranging a second plurality of elongate wires helically around said first plurality of elongate wires using a helical orientation opposite the orientation of said first plurality of elongate wires.

4. The method according to claim 3 wherein said arranging step comprises braiding said first plurality of elongate wires and said second plurality of elongate wires around said resilient body.

5. The method according to claim 1 comprising the step of applying an electrically conductive shield around said dielectric layer comprises longitudinally arranging said electrically conductive shield around said dielectric layer such that said electrically conductive shield has overlapping longitudinal edges.

6. The method according to claim 1 wherein said center resilient body comprises a polymeric material.

7. The method according to claim 6 wherein said polymeric material comprises a fluoropolymer.

8. The method according to claim 1 wherein said arranging step is performed by a mechanism selected from the group consisting of wrappers, braiders, winders, and twisters.

9. The method according to claim 8 wherein said plurality of elongate wires are applied by a process selected from the group consisting essentially of spirally wrapping said plurality of elongate wires in the same direction, spirally wrapping said plurality of elongate wires in opposite directions, and braiding said plurality of elongate wires.

10. The method according to claim 1, wherein said dielectric layer comprises a polymeric material.

11. The method according to claim 10 wherein said polymeric material comprises a fluoropolymer.

12. The method according to claim 1 wherein said applying step is performed by a process selected from the group consisting essentially of wrapping, extruding and coating.

13. A method of making an electrical contact comprising the steps of:
advancing a center resilient fluoropolymer body along a predetermined path of travel;
arranging a plurality of elongate wires around said center resilient body;
applying a fluoropolymer layer around said plurality of elongate wires and said center resilient body so as to form an axially continuous contactcable; and
cutting repeatedly said contact-cable so as to form a plurality of individual electrical contacts.

14. The electrical contact formed by the method of claim 13.

15. The electrical contact of claim 14 wherein there are a plurality of wires, each wire being wound in a spiral having a direction of wind, and the direction of wind of at least one of the wires is an opposite direction to the direction of wind of at least one of the other wires.

16. The electrical contact of claim 14 wherein a conductor is arranged upon said plurality of elongate wires so as to form an electrical shielding layer.

17. The electrical contact of claim 16 wherein said electrical shielding layer is a conductive wire mesh.

18. The electrical contact of claim 16 wherein said electrical shielding layer is a continuous metallic layer.

19. The electrical contact of claim 16 further comprising an insulating layer surrounding said shielding layer.

20. A method of making an electrical contact comprising the steps of:
advancing a center resilient fluoropolymer body along a predetermined path of travel;
arranging a first plurality of elongate wires around said center resilient body;
applying a fluoropolymer layer around said plurality of elongate wires and said center resilient body so as to form an axially continuous contactcable;
arranging a second plurality of elongate wires around said fluoropolymer layer; and
cutting repeatedly said contact-cable so as to form a plurality of individual electrical contacts.

21. The cable-contact formed by the method of claim 20.

22. A method for making an electrical contact comprising the steps of:
advancing a center resilient body along a predetermined path of travel;
arranging a plurality of elongate wires around said center resilient body;
wrapping a dielectric layer around said plurality of elongate wires and said center resilient body so as to form an intermediate assembly;
heating said intermediate assembly thereby at least partially melting said wrapped dielectric layer so as to form an axially continuous contactcable; and
cutting repeatedly said contact-cable so as to form a plurality of individual electrical contacts.

23. The method according to claim 22 wherein said arranging step comprises arranging the elongate wires helically around the underlying resilient body.

24. The method according to claim 22 wherein said wrapped dielectric material comprises a fluoropolymer.

25. The method according to claim 22 wherein said advancing center resilient body with said plurality of elongate wires wrapped therearound are both covered by a fluoropolymer.

26. The electrical contact formed by the method of claim 22.
